(19) United States
(12) Patent Application Publication
(10) Pub. No.: US 2006/0163424 A1
(43) Pub. Date: Jul. 27, 2006

(54) AeroStreamer Flight Kit

(76) Inventor: William Carl Stumphauzer II., South Lyon, MI (US)

Correspondence Address: PAUL K. GODWIN;BORDA, LORENZ & GEGGIE, PLLC, CRYSTAL GLEN OFFICE CENTRE, 39555 ORCHARD HILL PLACE, SUITE 370, NOVI, MI, 48375-5394, US

(21) Appl. No.: 11/162,357

(22) Filed: Sep. 7, 2005

Related U.S. Application Data
(60) Provisional application No. 60/610,257, filed on Sep. 16, 2004.

(51) Int. Cl. B64C 27/00

(52) U.S. Cl. 244/39

(57) ABSTRACT

A modified gliding ring toy comprised of lightweight connecting spokes, a low friction center hub, rotating center pin, and a tether attached to a tailpiece and/or promotional banner in order to provide both an apparent visual cue to the gliding ring's approach and an alternative means of catching it over a wide range of velocities in gliding flight. The user can utilize the AeroStreamer design modifications to retrieve a gliding ring in flight. While in flight, the gliding ring enhanced by the AeroStreamer modifications is easy to locate and presents the user with greater catching opportunities as the tether and tailpiece trail behind the gliding ring.

### FIELD OF THE INVENTION

This invention relates to amusement devices or toys, and, more specifically, aerial flying discs and ring devices.

### BACKGROUND INFORMATION

As anyone who has played catch with a highly efficient gliding ring knows, catching one in flight can often be quite difficult. Due to its thin profile and high rate of speed, a gliding ring is frequently difficult to locate in free space. In addition, the gliding ring's efficient design produces sudden changes in flight path trajectory when it encounters the slightest of breezes. The change in trajectory inevitably leaves the user racing frantically after the gliding ring. Thus, it is desirable to modify the gliding ring in a manner that permits the user to easily see, hear and catch the gliding ring during a normal game of catch.

### SUMMARY OF INVENTION

The AeroStreamer design modifications transform the Adler gliding ring, U.S. Pat. Nos. 4,560,358 (filed May 10, 1984) and 4,456,265 (filed Jan. 16, 1979), or other similar gliding ring designs into a user-friendly and visually appealing hybrid gliding ring. The design of the AeroStreamer Flight Kit consists of lightweight connecting spokes, a low friction center hub, rotating center pin, and a tether attached to a tailpiece and/or promotional banner. The AeroStreamer model variation of the present Adler gliding ring requires a design modification to the inner ring mold for the inclusion of two or three spokes and center hub using the same material. Either variation of the AeroStreamer implementation is intended to accompany the gliding ring in flight. When attached to a gliding ring, the kit or model variation provide both a strong visual cue to the gliding ring's approach and an alternative means of catching it.

### BRIEF DESCRIPTION OF THE DRAWINGS

The accompanying drawings, which are incorporated in and constitute a part of the specification, illustrate exemplary embodiments of the present invention.

FIG. 1 illustrates a planform of the AeroStreamer design modifications incorporated into the present Adler gliding ring design.

FIG. 2 illustrates a simplified cross-section of the Adler gliding ring, highlighting the AeroStreamer modified design to the high-impact thermoplastic inner ring.

FIG. 3 illustrates a cross-section of the AeroStreamer Flight Kit attached to an existing Adler gliding ring.

FIG. 4 illustrates the planform of the Adler gliding ring joined to the connecting spokes of the AeroStreamer Flight Kit.

FIG. 5 illustrates the general shape and function of a basic tailpiece.

### DETAILED DESCRIPTION OF THE INVENTION

The present invention features a method that allows a user to more easily locate and catch a highly efficient gliding ring, such as the Adler model sold under the Aerobie name. There are several ways to incorporate the design enhancements of the AeroStreamer Kit into the current Adler gliding ring. The optimal solution involves modifying the present mold of the inner high-impact thermoplastic ring to include two or three connecting spokes and the center hub. The center hub houses the central rotating pin, which is connected to the adjustable length tether and trailing tailpiece. The trailing tailpiece is made of lightweight foam or plastic and is suitable for both catching and superior sight recognition.

As an alternative to incorporating the AeroStreamer modifications into the Adler gliding ring's existing design, a retrofit method can also be employed. The AeroStreamer Flight Kit utilizes the Adler gliding ring's existing flow-through holes located on the inner diameter of the polycarbonate ring as spoke attachment points. Connecting spokes are inserted through the flow-through holes and attach to the hub in a manner suitable for aftermarket assembly.

Either implementation provides the necessary functionality for improving the current utility of highly efficient gliding rings. Modifying the existing design of the Adler gliding ring available in the market today presents the user with an integrated functionality enhancement. Incorporating the changes through a retrofit kit provides the same functionality as the integrated approach, but in a manner that is reversible to the gliding ring.

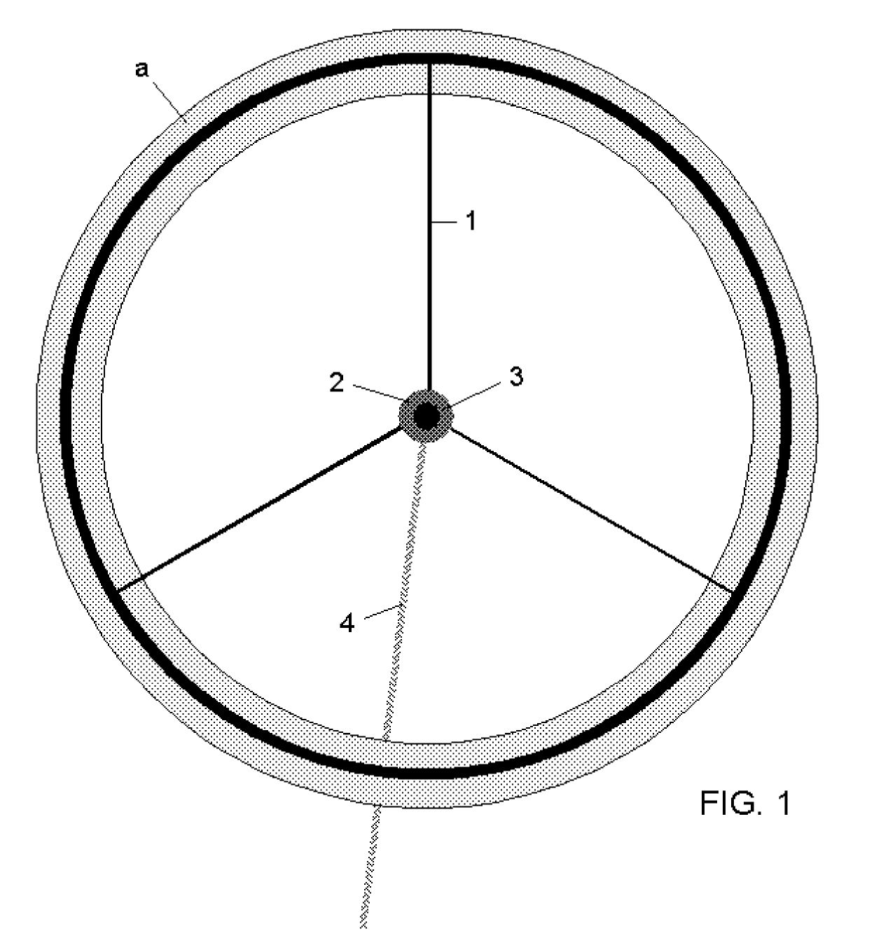

FIG. 1 is a planform of the AeroStreamer modification incorporated into the present Adler gliding ring design (a). The model variation consists of lightweight connecting spokes (1), a low friction hub (2), a clevis pin or axle piece (3), and an adjustable length tether (4).

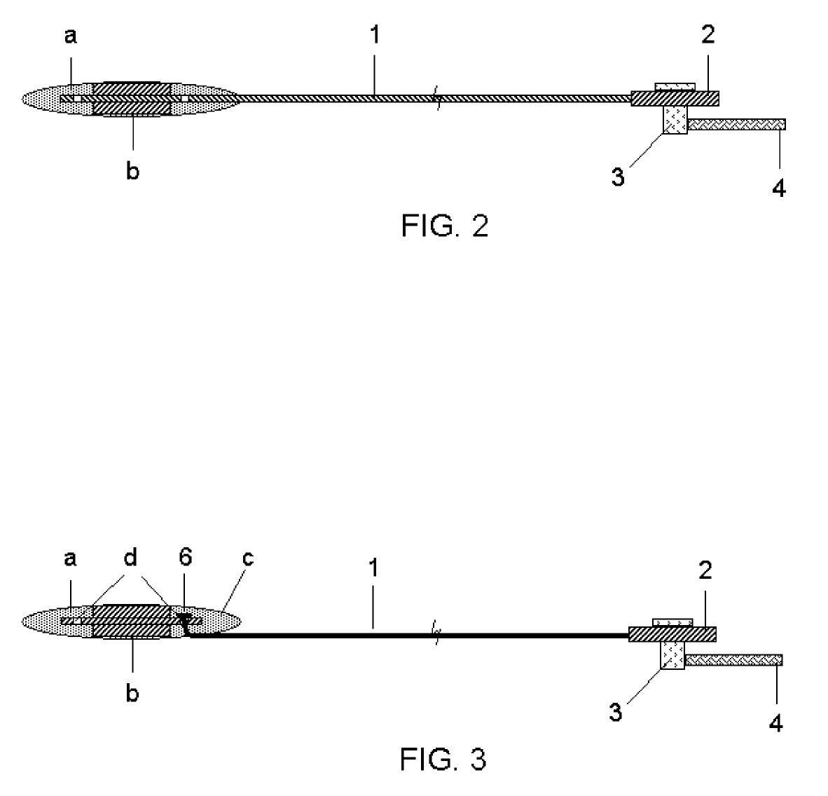

FIG. 2 shows a simplified cross-section of the Adler gliding ring (a), highlighting the high-impact thermoplastic inner ring (b). In a model variation of the Adler gliding ring incorporating the AeroStreamer Kit, the support spokes (1) are molded with the inner thermoplastic ring (b) and the low friction center hub (2). The tether or streamer (4) is attached to the hub (2) with the central rotating pin or axle piece (3).

FIG. 3 is a cross-section of the AeroStreamer Flight Kit attached to an off the shelf Adler gliding ring (a). As a separate kit, the connecting spokes (shortened bicycle spokes) (1), low friction center hub (2), rotating center pin (3), and adjustable length tether (4) are joined to the Adler gliding ring at the inner diameter flow-through holes located 120° apart from another. The right angle portion of the spokes (6) pierce through the thermoplastic elastomer (c) and into the high-impact plastic ring (b). The preexisting flow-through holes (d) within the thermoplastic ring (b) provide an ideal mechanism to securely fasten the AeroStreamer Flight Kit to the to the Adler gliding ring.

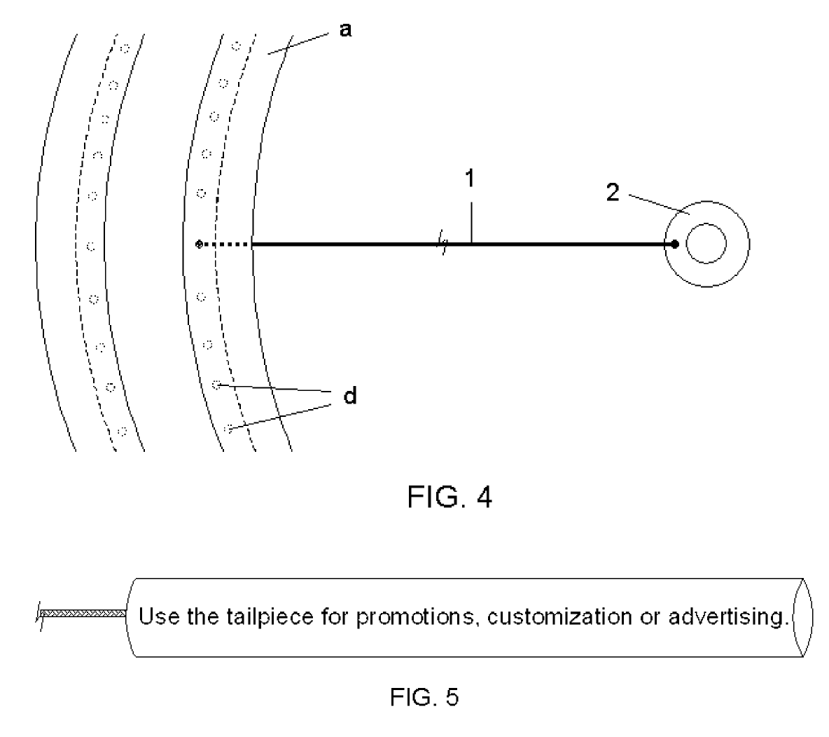

FIG. 4 illustrates the planform of the Adler gliding ring (a) joined to the connecting spokes (1) and low friction center hub (2), using the preexisting flow-through holes (d).

FIG. 5 illustrates the general shape and function of a basic tailpiece. The purpose of the tailpiece in the exemplary embodiment is to provide a visual catching aid and/or present an audible indication of approach. The tailpiece can take many aerodynamic shapes and sizes to facilitate and improve the gliding ring catching process. The tailpiece can be made of any lightweight material suitable for ease of manufacturability and user friendliness.

It is possible to forego the tailpiece entirely and use a single piece of lightweight material such as nylon ribbon. The in flight appearance of nylon ribbon trailing behind the gliding ring in flight resembles that of an airborne kite.

1. An assembly kit suitable for attachment to and modification of a gliding ring toy, comprising;
a plurality of connecting spokes,
a central hub,
a central rotating pin,
an adjustable length tether, and
a trailing tailpiece.

2. An assembly kit as recited in claim 1 wherein said connecting spokes are connected to a flying ring and join the flying ring to said central hub.

3. An assembly kit as recited in claim 1 wherein said central hub houses the central rotating pin.

4. An assembly kit as recited in claim 1 wherein said central rotating pin is permitted to rotate freely within central hub.

5. An assembly kit as recited in claim I wherein said central rotating pin is attached to said adjustable length tether.

6. An assembly kit as recited in claim I wherein said adjustable length tether is attached to said trailing tailpiece.

7. An assembly kit as recited in claim I wherein said trailing tailpiece provides an area for advertisements, promotions and other customization.

8. An assembly kit as recited in claim I wherein said trailing tailpiece provides a visual aid to enhance in flight retrieval of modified ring toy.

9. An assembly kit as recited in claim I wherein said trailing tailpiece provides an audible indication of approach of a modified ring toy in flight.

10. An assembly kit as recited in claim I wherein said trailing tailpiece can be substituted for a length of lightweight material.

11. A gliding ring toy comprising an airfoil having outer and inner concentric circular edges surrounding a central open circular area;
a plurality of radial spoke elements having first and second ends; said first ends being equally spaced and connected to said airfoil so that said spoke elements each converge in a plane towards the center of said circular area;
a central hub element having a freely rotatable connection element extending beneath its center;
said second ends of said spokes each being connected to said hub element to locate said hub element at the center of said open circular area; and
a free-ended lightweight line connectable to said connection element and beneath said airfoil to provide visual and catching enhancements to said ring toy.

12. A gliding ring toy as in claim 11, wherein said spokes form a spider-like connection between said air foil and said cylindrical hub.

13. A gliding ring toy as in claim 11, wherein said connection of said lightweight line to said pin is attachable and detachable.

14. A gliding toy as in claim 11, wherein said light-weight line is connected to said pin element to function as a tether.

15. A gliding toy as in claims 11, wherein a light-weight line is connected to said pin element to function as a tail.

16. An improved gliding ring toy comprising an airfoil having outer and inner concentric circular edges surrounding a central open circular area and a central inner support ring element being mold formed during the manufacturing process of said gliding ring toy; wherein said improvement comprises:
a plurality of spider-like radial spoke elements being molded integral with said central inner support ring so as to be equally spaced from each other and extending through said inner edge to have ends that converge in a plane towards the center of said circular area;
a central hub element containing a central cylindrical opening having its axis oriented perpendicular to said plane;
said converging ends of said spokes each being connected to said hub element and;
a connection element extending from said central cylindrical opening to provide a freely rotatable connection point.

17. A gliding toy as in claim 16, wherein a light-weight line is connected to said connection point to provide a tail.

18. A gliding toy as in claim 16, wherein said central hub is molded along with said spokes to form a unitary structure with said gliding ring.

19. A gliding toy as in claim 18, wherein a light-weight line is connected to said connection point to provide a tail.

20. A gliding toy as in claim 18, wherein a light-weight line is connected to said connection point to provide a tether.
